(19) United States
(12) Patent Application Publication
(10) Pub. No.: US 2001/0026541 A1
(43) Pub. Date: Oct. 4, 2001

(54) Method for performing diversity and handoff in all internet protocol network

(76) Inventors: In-Ho You, Ichon-shi (KR); Jae-Hong Park, Ichon-shi (KR); Yeon-Sang Koo, Ichon-shi (KR)

Correspondence Address: BAKER & BOTTS, 30 ROCKEFELLER PLAZA, NEW YORK, NY, 10112

(21) Appl. No.: 09/788,757

(22) Filed: Feb. 20, 2001

(30) Foreign Application Priority Data
Feb. 19, 2000 (KR) 2000-8064
Sep. 5, 2000 (KR) 2000-52509

(51) Int. Cl. H04Q 7/00

(52) U.S. Cl. 370/331; 370/338; 370/349

(57) ABSTRACT

A method for performing a diversity and a handoff in All IP network is disclosed. The method for performing a handoff in All IP network includes the steps of: a) at a mobile station communicating with a first base transceiver station (BTS), determining whether a strength of a pilot signal from a second BTS is lager than a threshold value; b) if the strength of the pilot signal from the second BTS is lager than the threshold value, adding a handoff from the first BTS to the second BTS; c) communicating with the all IP network through the first BTS and the second BTS based on a diversity function; d) determining whether a strength of a pilot signal from the first BTS is smaller than the threshold value; e) if the strength of the pilot signal from the first BTS is smaller than the threshold value, requesting a handoff remove; and f) releasing a traffic channel between the MS and the first BTS.

### FIELD OF THE INVENTION

The present invention relates to a mobile communication system; and, more particularly to a method for performing diversity and handoff in an all Internet protocol network.

### PRIOR ART OF THE INVENTION

FIG. 1 shows a conventional IMT-2000 system network.

Referring to FIG. 1, the international mobile telecommunication-2000 (IMT-2000) system includes mobile stations (MS) 100 and 101, a base transceiver station (BTS) 102, a base station controller (BSC) 103, a mobile switching center (MSC) 105 and an IMT-2000 core network 106.

When the mobile station (MS) 101 moves in cell coverage of the BTS 102, information about the MS is transmitted to the MSC 105 through the BTS 102 and the BSC 103. Information from the MSC 103 is transmitted to the MS 101 through the BTS 102 and the BSC 103.

In conventional second and third generation mobile communication systems, a diversity function is used in order to increase communication quality when the BTS receives data from the MS during the handoff.

Here, the diversity function means that one mobile station (MS) is connected to two or more base transceiver stations (BTSs), and the base station controller (BSC) receives data frames from the MS through two or more BTSs. The BSC selects one data frame in the data frames received through two or more BTSs. The BSC distributes the selected data frame to the BTSs. In other words, the same data is transmitted through multiple paths in the conventional circuit network, the BTS selects the data frame having best quality in the data frames received through the multiple paths.

Nowadays, in two International standardization meeting groups, a third generation partnership projects (3GPP) and a 3GPP2, a change of the IMT-2000 network to an all Internet protocol (All IP) network and standards for the All IP network has been discussed. The All IP network is a mobile communication network based on an Internet protocol. In the All IP network, packet-based data is transferred.

FIG. 2 shows a reference model of the All IP network proposed to a 3GPP2 All IP Adhoc.

Referring to FIG. 2, the All IP network includes a home subscriber subsystem (HSS) 211, a feature server 212, a call control function unit 213, a roaming gateway 214, a packet gateway 215, a circuit gateway 216, a legacy system 217, a public switched telecommunication network (PSTN) 218 and an Internet network 219.

The HSS 217, which performs functions as similar to a home location register (HLR) and an authentication center (AC), stores user information, authentication algorithms, locations, etc. of mobile stations 201-203. The feature server performs a call processing. The call control function unit 213 performs the call processing control function. The roaming gateway 214 performs connection to a 2G network. The packet gateway 215 performs connection to the Internet work (not to the IMT-2000 network). The circuit gateway 216 performs connection to the PSTN 218.

Each gateway utilizes a dual protocol stack for connection between networks of which protocols are different from each other, and performs an address mapping.

In the All IP network, which a handoff method in accordance with the present invention is applied thereto, there is no base station controller (BSC), base transceiver stations are directly coupled to the Internet Protocol (IP) network. In other words, the functions of the BSC are to be distributed to the BTS and an IP core network and the BTS is to be an IP node.

A final reference model of the All IP network has not yet established, however, the BTS is possible to be the IP node in at least 3GPP2. In this case, structure of a radio access network having the BTS and the BSC is to be considerably changed.

When performing the handoff, in order to increase quality of the data frames transmitted from the MS to the network, the diversity function is used.

Referring to these situations, the data frame selection function should be transferred from the BSC to the BTS or to the IP core network. However, since the IP core network is difficult to select the data frame, as shown in FIG. 2, the BTS could perform the data frame selection function. At this time, data transmission between the BTSs can be frequently occurred, and therefore, it is important to select an appropriate location of frame selection and distribution function unit.

In other hands, since different data is transmitted through the multiple paths in the all Internet protocol network, it is a problem that the diversity function cannot be used. Also, there is another problem in that a communication quality is not yet guaranteed. In other words, a real time processing is necessary for a frame selection/distribution function, however, the real time processing is not guaranteed in the IP network.

### SUMMARY OF THE INVENTION

Therefore, it is an object of the present invention to provide a method for performing diversity and handoff in an all Internet protocol network.

In accordance with an aspect of the present invention, there is provided to a method for performing a diversity in an all Internet protocol (All IP) network, comprising the steps of: a) at a first BTS, receiving a first data frame from a MS and a second data frame through a second BTS from the MS; b) at the first BTS, checking an error (or errors) in each of the first and the second data frames; and c) at the first BTS, selecting one data frame having less error(s).

In accordance with another aspect of the present invention, there is provided to a method for performing a diversity in an all Internet protocol (All IP) network, comprising the steps of: a) at a first BTS, receiving a data frame from an IP network; b) at the first BTS, duplicating the data frame; c) at the first BTS, transmitting one of the duplicated data frames to a mobile station (MS) directly and the other to the MS through the second BTS; d) at the MS, checking an error (or errors) in each of the data frames from the first and the second BTS; and e) at the MS, selecting one data frame having less error(s).

In accordance with further another aspect of the present invention, there is provided to a method for performing a diversity in an all Internet protocol (All IP) network, comprising the steps of: a) at a frame selection/distribution means, receiving a first data frame through a first BTS and a second frame through a second BTS from a MS; b) at the frame selection/distribution means, checking an error (or errors) in each of the first and the second data frames; and c) at the frame selection/distribution means, selecting one data frame having less error(s).

In accordance with still further another aspect of the present invention, there is provided to a method for performing a diversity in an all Internet protocol (All IP) network, comprising the steps of: a) at a frame selection/distribution means, receiving a data frame from an IP network; b) at the frame selection/distribution means, duplicating the data frame; c) at the frame selection/distribution means, transmitting one of the duplicated data frames to a mobile station (MS) directly and the other to the MS through the second BTS; d) at the MS, checking an error (or errors) in each of the data frames from the first and the second BTS; and e) at the MS, selecting one data frame having less error(s).

In accordance with still another aspect of the present invention, there is provided to a method for performing a handoff in an all Internet protocol (All IP) network, comprising the steps of: a) at a mobile station (MS) communicating with a first base transceiver station (BTS), determining whether a strength of a pilot signal from a second BTS is lager than a threshold value; b) if the strength of the pilot signal from the second BTS is lager than the threshold value, at the MS, requesting a handoff add from the first BTS to the second BTS; c) communicating with an Internet protocol (IP) network through the first BTS and the second BTS based on a diversity function; d) determining whether a strength of a pilot signal from the first BTS is smaller than the threshold value; e) if the strength of the pilot signal from the first BTS is smaller than the threshold value, requesting a handoff remove; and f) releasing a traffic channel between the MS and the first BTS.

### BRIEF DESCRIPTION OF THE DRAWINGS

Other objects and aspects of the invention will become apparent from the following description of the embodiments with reference to the accompanying drawings, in which:

FIG. 1 is a block diagram illustrating a network of a conventional IMT-2000 system;

FIG. 2 is a block diagram showing a reference model of the All IP network proposed to a 3GPP2 All IP Adhoc;

FIG. 3 is a diagram illustrating all Internet protocol network applied to one embodiment of the present invention;

FIG. 4 is a diagram illustrating all Internet protocol network applied to another embodiment of the present invention;

FIG. 5 is a diagram illustrating all Internet protocol network applied to another embodiment of the present invention;

FIGS. 6A and 6B are flow charts illustrating a handoff method when a BTS performs a frame selection/distribution function in the all Internet protocol network;

FIG. 7 is a flow chart illustrating a diversity method when a BTS performs a frame selection/distribution function in the all Internet protocol network;

FIGS. 8A and 8B are flow charts illustrating a handoff method when a RAN gateway performs a frame selection/distribution function in the all Internet protocol network; and

FIG. 9 is a flow chart illustrating a diversity method when a RAN gateway performs a frame selection/distribution function in the all Internet protocol network.

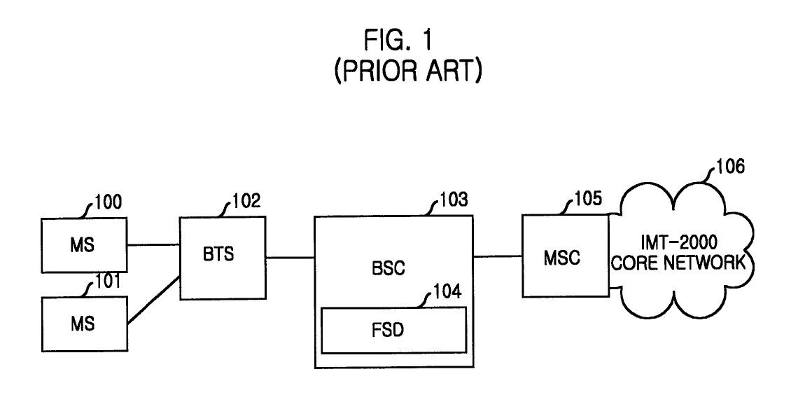

### DETAILED DESCRIPTION OF THE PREFERRED EMBODIMENTS

Hereinafter, preferred embodiments of the present invention will be described in detail referring to the accompanying drawings.

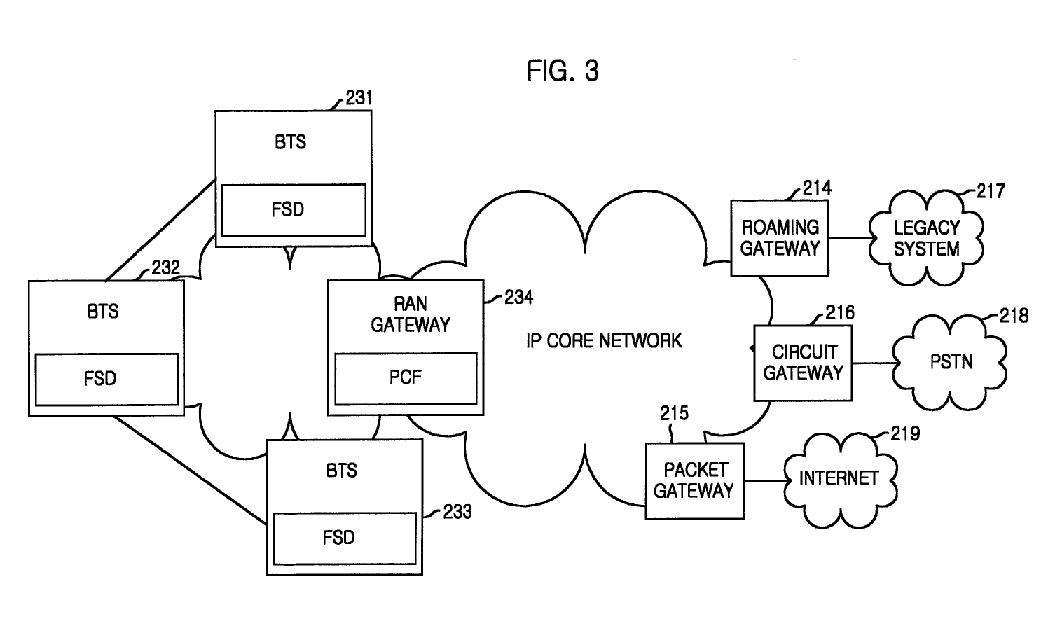

FIG. 3 is a diagram illustrating all Internet protocol network applied to one embodiment of the present invention.

Reference numerals 231 to 233 denote base transceiver stations each of which includes a frame selection/distribution unit. A reference numeral 234 denotes a radio access network (RAN) gateway performing a connection between the radio access network and the IP network.

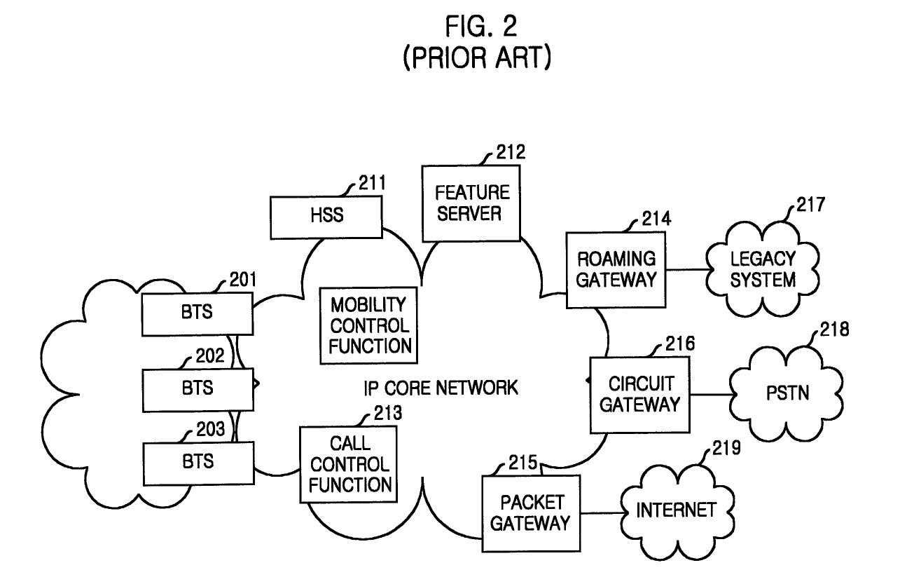

The other blocks have the same functions as those mentioned above with reference to FIG. 2. Accordingly, for easy description, detailed descriptions about the other blocks will be skipped.

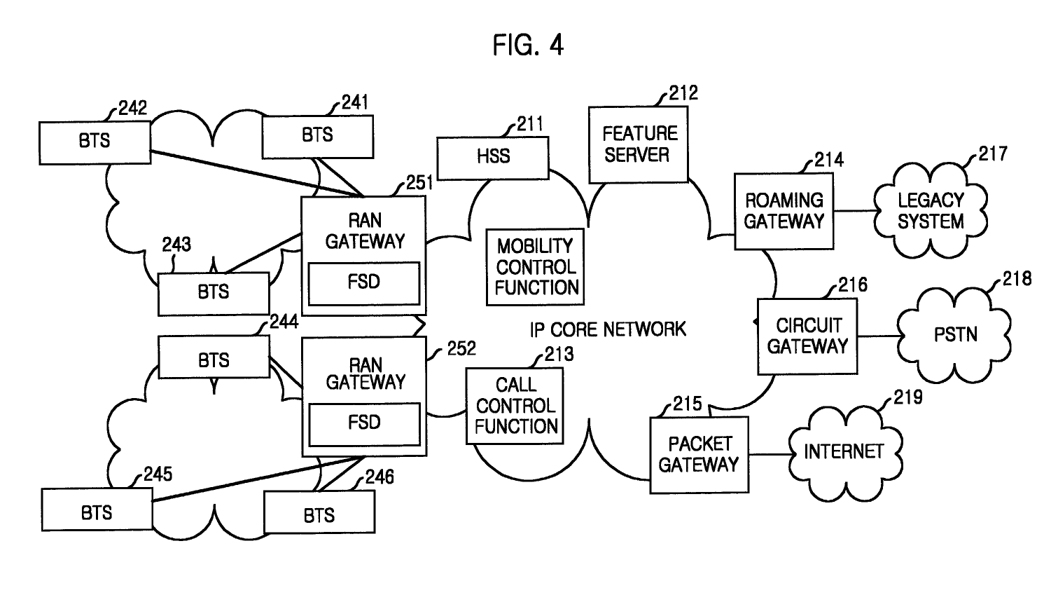

FIG. 4 is a diagram illustrating all Internet protocol network applied to another embodiment of the present invention.

Reference numerals 241-246 denote base transceiver stations (BTSs) interfacing the MS with the IP network, and 251 and 252 radio access network (RAN) gateways performing frame selection/distribution function.

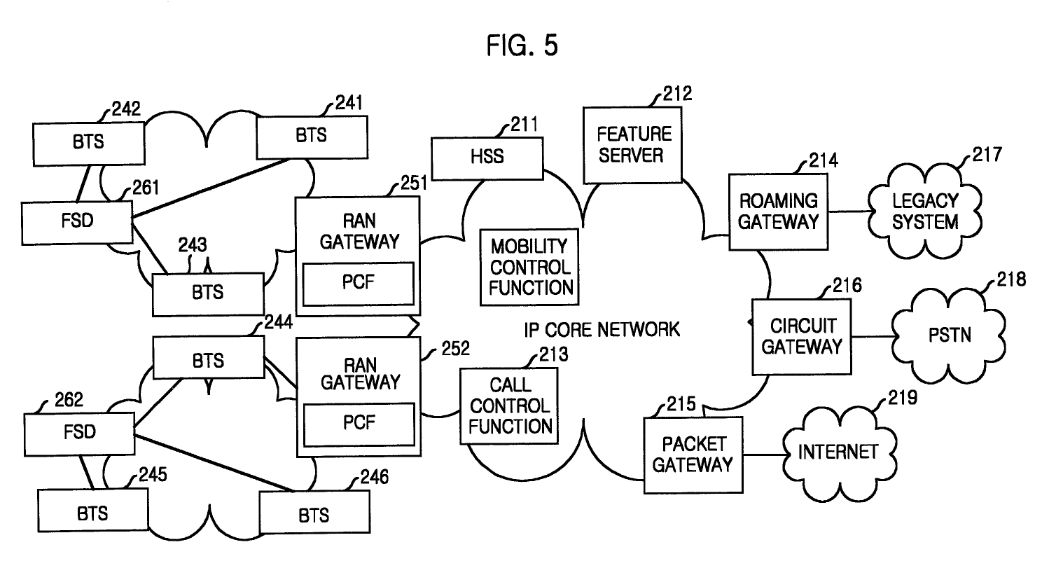

The BTS performs combination function of signals from the multiple paths. The RAN gateway performs the frame selection/distribution function and connection between the radio access network and the IP network. The frame selection/distribution function can be performed by a separate device not by the BTS and the RAN gateway. Structure of this network is illustrated in FIG. 5.

Hereinafter, three handoff methods in accordance with the present invention will be described. One of them is a handoff method in case that the frame selection/distribution function is performed in each of the BTSs and the packet control function is performed in the RAN gateway. Another is a handoff method in case that the frame selection/distribution function and the packet control function are performed in the RAN gateway. The other is a handoff method in case that the frame selection/distribution function is performed in the separate device and the packet control function is performed in the RAN gateway.

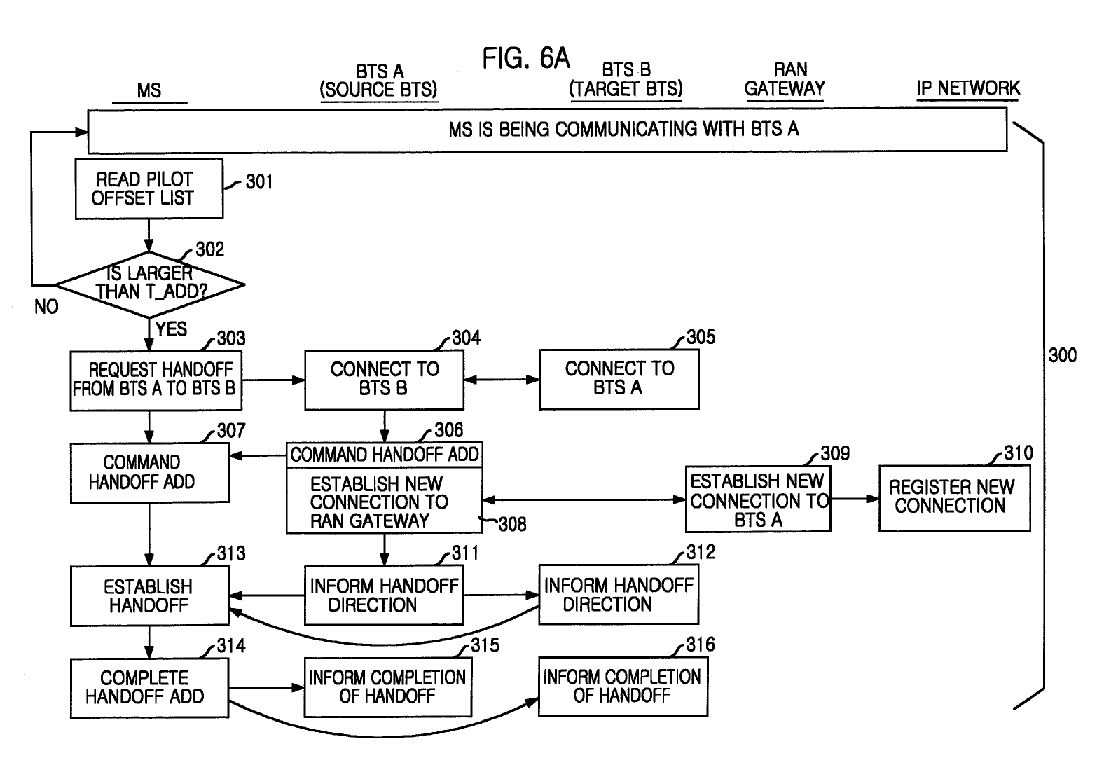

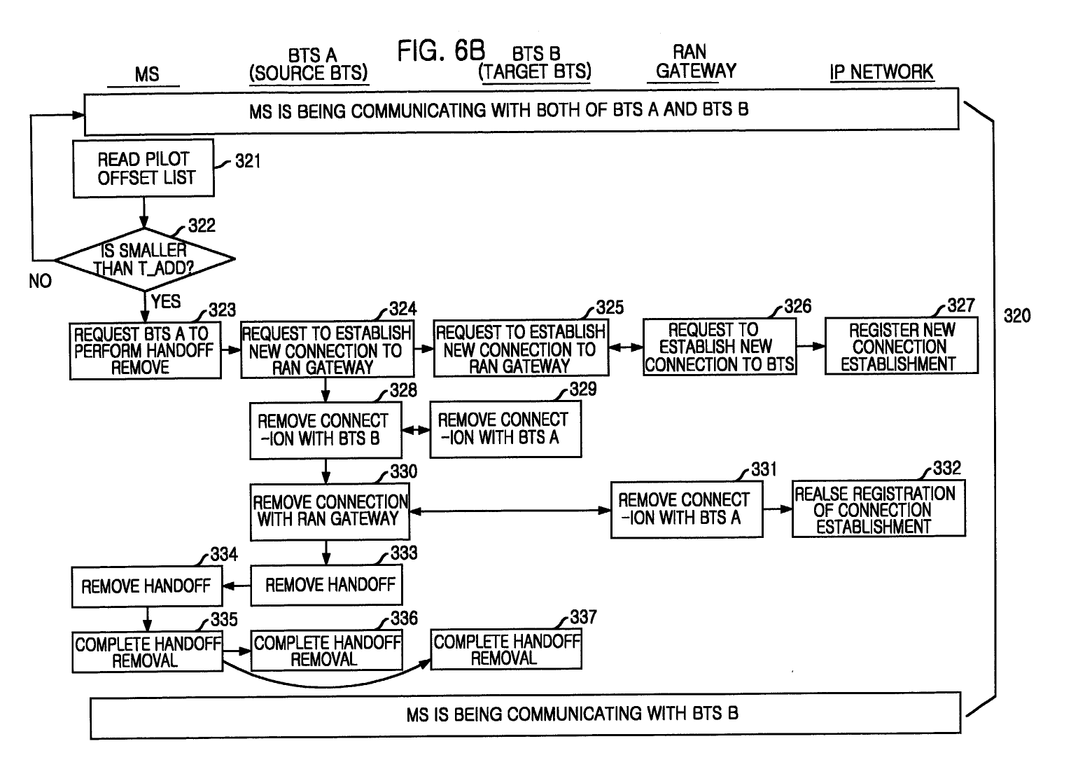

FIGS. 6A and 6B are flow charts illustrating a handoff method when each BTS performs a frame selection/distribution function in the all Internet protocol network.

In this specification, it is referred to as “handoff add” establishment of a traffic channel between a target BTS (BTS B) and the MS currently communicating with a source BTS (BTS A). It is referred to as “handoff remove” disconnection of the traffic channel between the MS and the source BTS (BTS A).

Referring to FIG. 6A, the handoff add procedure is illustrated.

First, the MS, which is communicating with the BTS A (source BTS) through the traffic channel, reads a pilot offset list at step 301. The MS determines whether a strength of a pilot signal received from the BTS B (target BTS) is larger than a handoff add threshold value at step 302. If the strength of the pilot signal from the BTS B is larger than a handoff add threshold value, the MS requests the BTS A to perform the handoff add at step 303. The BTS A establishes a connection to the BTS B at steps 304 and 305. The BTS A transmits the handoff add command to the MS at steps 306 and 307 and establishes a new connection to the RAN gateway at step 309. The RAN gateway registers the new connection to a mobility control unit of the network at step 310.

The BTS A informs the BTS B and the MS of a handoff direction message at step 311, and then the BTS B re-transmits the handoff direction message to the MS at step 312.

The MS receives the handoff add command and the handoff direction message, performs the handoff add at step 313, and then transmits a handoff add completion message to the base stations A and B at steps 314 to 316. At this time, the MS has traffic channels to both of the BTS A and the BTS B.

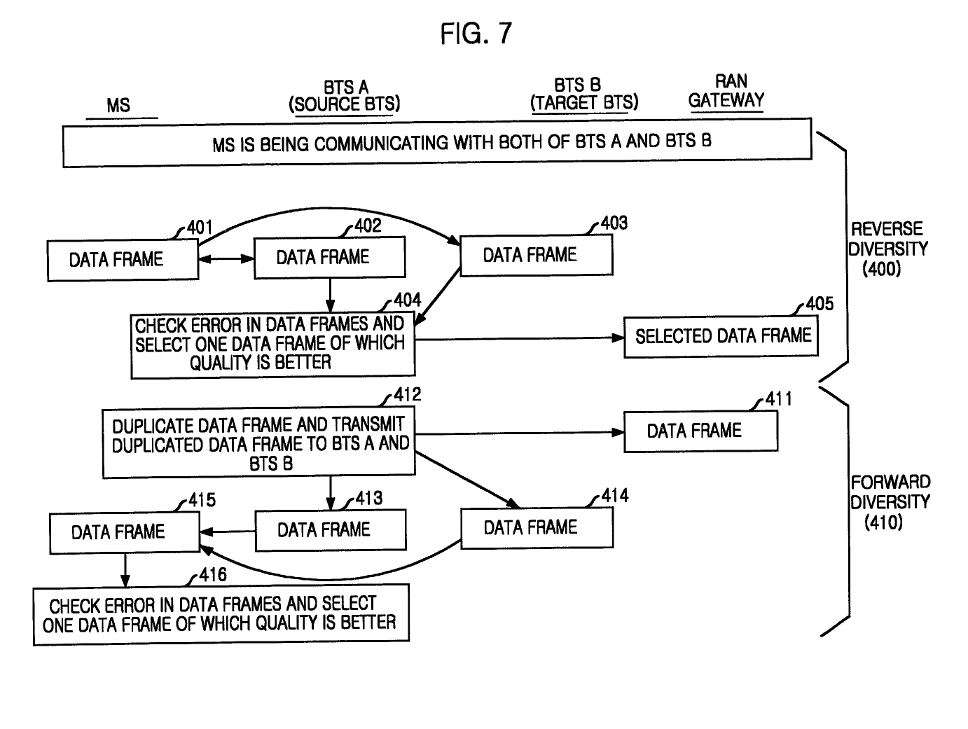

In the BTS A, the diversity function to the data frame between the MS and the All IP network is performed. The diversity procedure will be described with reference to FIG. 7.

Referring to FIG. 6B, the handoff remove procedure is illustrated.

The MS connected to both of the BTS A and BTS B reads the pilot offset list at step 321, and determines whether the strength of the pilot signal received from the BTS A (source BTS) is smaller than the handoff add threshold value T_ADD at step 322. If the strength of the pilot signal from the BTS A is smaller than the handoff add threshold value T_ADD, the MS requests the BTS A to perform the handoff remove at step 323.

If the BTS A requests the BTS B to establish a new connection to the RAN gateway at step 324, the BTS B establishes the new connection to the RAN gateway at step 325. The RAN gateway establishes the new connection and registers the new connection to the mobility control unit at step 327.

The BTS A disconnects the traffic channel for the connection to BTS B at step 328, and then release the connection to the RAN gateway at step 330. At this time, the BTS B releases the connection to the BTS A at step 329.

The RAN gateway disconnects the connection to the BTS A and releases the registration of the connection in the mobility control unit at step 332.

If the BTS A informs the MS of a handoff remove command at step 333, the MS performs the handoff remove at step 334 and transmits a handoff remove completion message to two base transceiver stations (i.e., BTS A and BTS B), thereby ending the handoff remove procedure at steps 336 and 337.

FIG. 7 is a flow chart illustrating a diversity method when a BTS performs a frame selection/distribution function in the all Internet protocol network.

The diversity function means that one mobile station (MS) is connected to two or more base transceiver stations (BTSs) and the base station controller (BSC) receives frame data from the MS through two or more BTSS. The BSC selects one frame data from the frame data received through two or more BTSs. The BSC distributes the selected frame data the BTSs. In other words, since the same data is transmitted through multiple paths in the conventional circuit network, the BTS can select the frame data of which quality is better.

The reference numeral 400 denotes a reverse diversity procedure. When the MS is connected to both of the BTS A and the BTS B so that the MS is possible to communicate with the BTS A and the BTS B, the BTS A receives the data frame from the MS at steps 401 and 402 and the data frame received through the BTS B from the MS at step 403. The BTS A detects an error(s) in each of the data frames, selects the data frame of which the quality is better, and then transmits the selected data frame to the RAN gateway at step 405.

The reference numeral 410 denotes a forward diversity procedure. The BTS A receives data frames from the RAN gateway and duplicates the data frames and transmits the data frame to both of the BTS A and the BTS B at steps 411 and 412. Each of the BTSs transmits the data frame received from the RAN gateway at steps 413 and 414. The MS selects one of the data frames received from the BTS A and the BTS B, of which quality is better at step 416.

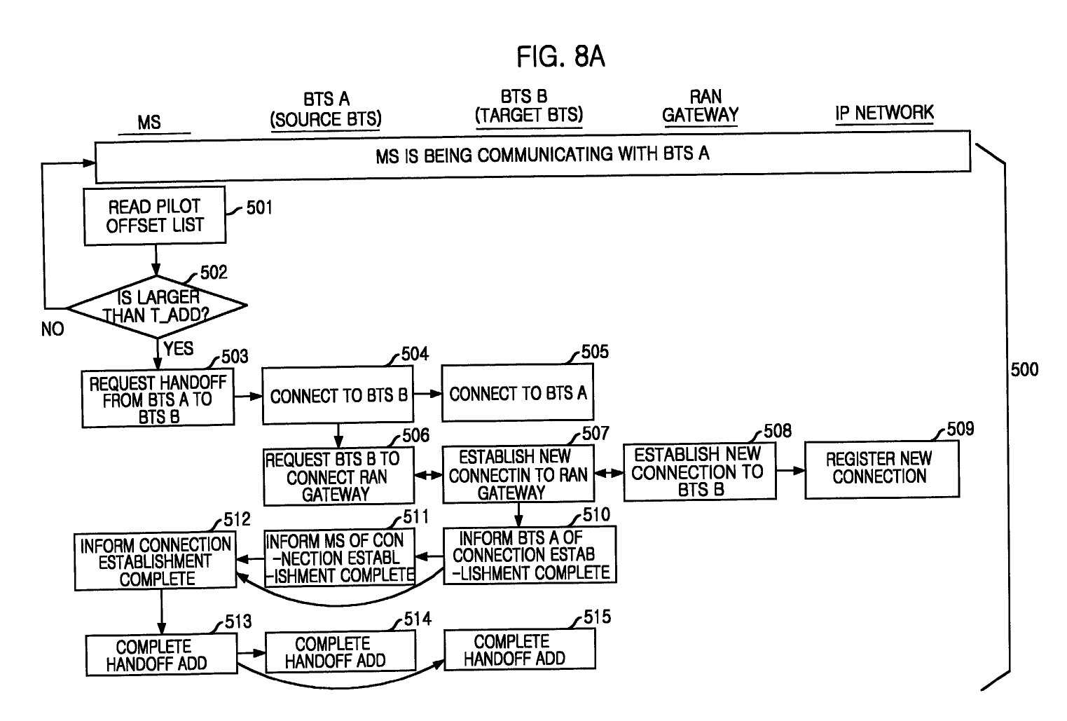

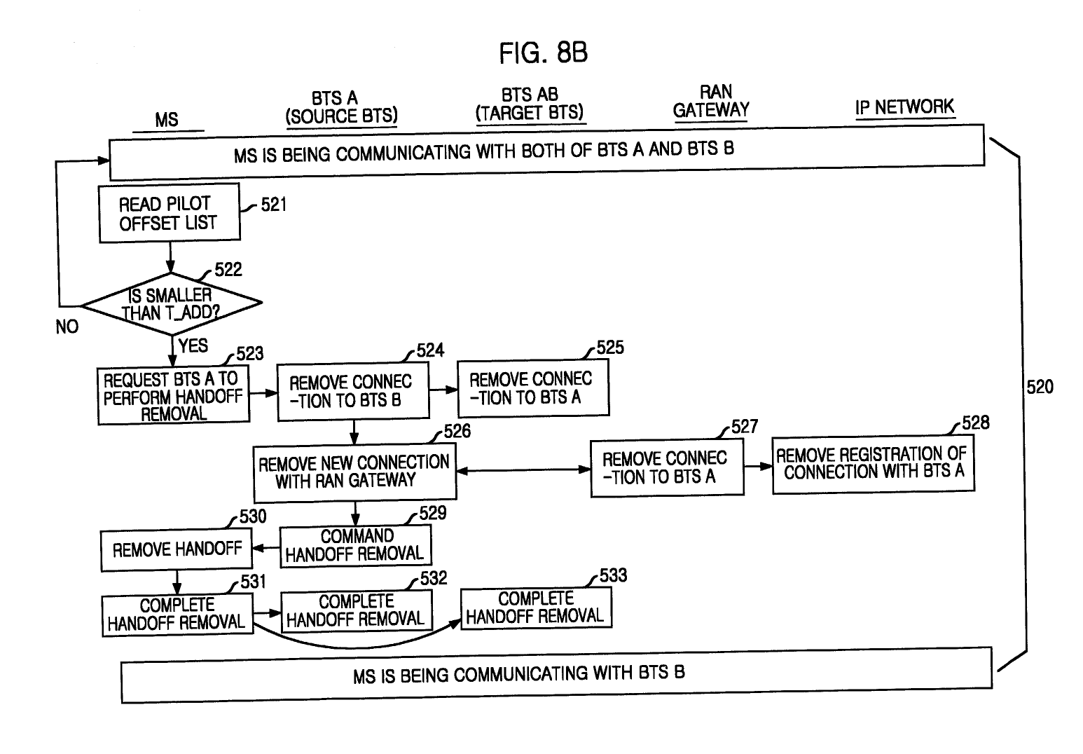

FIGS. 8A and 8B are flow charts illustrating a handoff method when a RAN gateway performs a frame selection/distribution function in the all Internet protocol network.

Referring to FIG. 8A, the handoff add procedure is illustrated.

First, the MS, which is communicating with the BTS A (source BTS) through the traffic channel, reads a pilot offset list at step 501. The MS determines whether a strength of a pilot signal received from the BTS B (target BTS) is larger than a handoff add threshold value at step 502. If the strength of the pilot signal from the BTS B is larger than a handoff add threshold value, the MS requests the BTS A to perform the handoff add at step 503. The BTS A establishes a connection to the BTS B at steps 504 and 505. The BTS A requests the BTS B to establish a new connection to the RAN gateway at step 506.

The BTS B establishes a new connection to the RAN gateway at steps 507 and 508 and RAN gateway registers the new connection to a mobility control unit of the network at step 509.

The B informs the BTS A and the MS that the new connection to the RAN gateway is completed at step 510 to 512. The BTS A informs the MS of the connection completion to the RAN gateway at step 511.

The MS transmits the handoff add completion message to the BTS A and the BTS B at steps 513 to 515. The MS is connected to both of the BTS A and the BTS B. In this embodiment, it is preferred that data signals between the BTS and the frame selection/distribution unit are exchanged through a direct path for the real time processing. However, if the Internet can provide the real time processing, the direct path is not necessary.

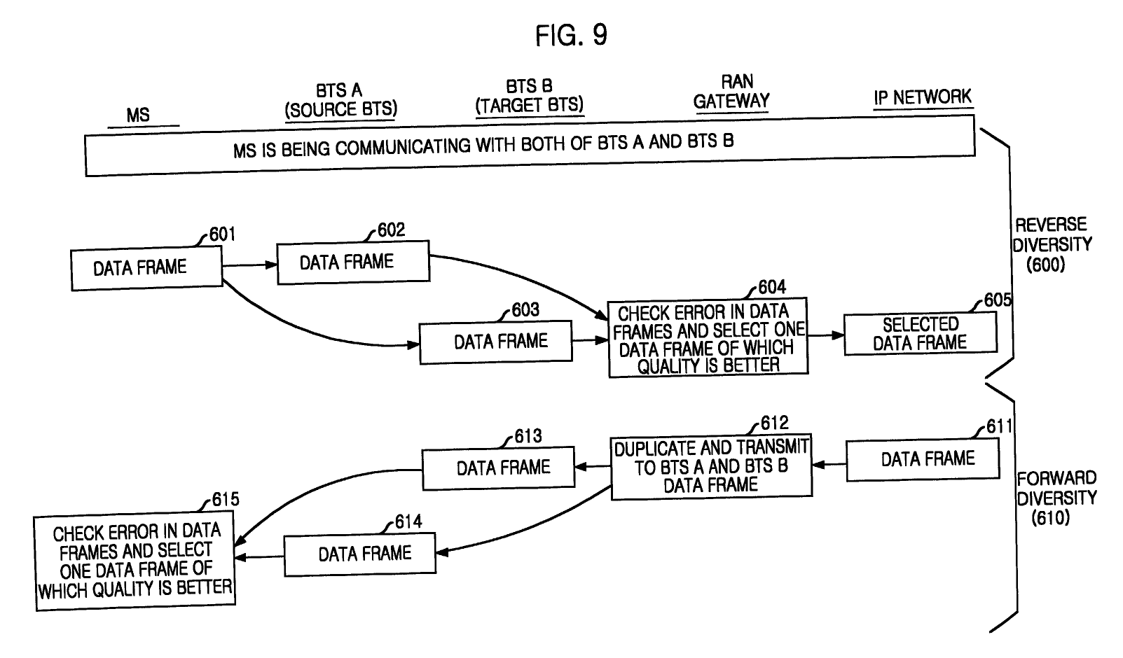

In RAN gateway, the diversity function to the data frame between the MS and the All IP network is performed. The diversity procedure will be described with reference to FIG. 9.

Referring to FIG. 8B, the handoff remove procedure is illustrated.

The MS connected to both of the BTS A and BTS B reads the pilot offset list at step 521, and determines whether the strength of the pilot signal received from the BTS A (source BTS) is smaller than the handoff add threshold value T_ADD at step 522. If the strength of the pilot signal from the BTS A is smaller than the handoff add threshold value T_ADD, the MS requests the BTS A to perform the handoff remove at step 523.

The BTS A releases the connection to the BTS B at steps 524 and 525. The BTS A releases the connection the RAN gateway at step 526. The RAN gateway releases the connection to the BTS A at step 527 and the connection registration in the mobility control unit at step 528.

If the BTS A transmits the handoff remove command to the MS, the MS performs the handoff remove command at step 530, and then transmits the handoff remove command complete message to the BTS A and the BTS B at step 530 to 532, thereby completing the handoff remove procedure.

FIG. 9 is a flow chart illustrating a diversity method when a RAN gateway performs a frame selection/distribution function in the all Internet protocol network.

The reference numeral 600 denotes a reverse diversity procedure. When the MS is connected to both of the BTS A and the BTS B so that the MS is possible to communicate with the BTS A and the BTS B, the RAN gateway receives the data frame from the MS through the BTS A at steps 601 and 602 and the data frame through the BTS B at steps 601 and 603. The BTS A detects an error(s) in each of the data frames, selects the data frame of which the quality is better, and then transmits the selected data frame to the RAN gateway at step 605.

The reference numeral 610 denotes a forward diversity procedure. The RAN gateway receives data frames from the network and duplicates the data frames and transmits the duplicated data frame to both of the BTS A and the BTS B at steps 611 and 612. Each of the BTSs transmits the data frame received from the MS at steps 613 and 614. The MS selects one of the data frames received from the BTS A and the BTS B, of which quality is better at step 615.

In case of the handoff from the source BTS to the target BTS, the MS establishes one new traffic channel with the target BTS and communicates two BTS based on the diversity function, before disconnecting the traffic channel with the source BTS. Therefore, the quality of the communication can be kept as high during the handoff.

Although the preferred embodiments of the invention have been disclosed for illustrative purpose, those skilled in the art will appreciate that various modifications, additions and substitutions are possible, without departing from the scope and spirit of the invention as disclosed in the accompanying claims.

What is claimed is:

1. A method for performing a diversity in an all Internet protocol (All IP) network, comprising the steps of:
a) at a first BTS, receiving a first data frame from a MS and a second data frame through a second BTS from the MS;
b) at the first BTS, checking an error (or errors) in each of the first and the second data frames; and
c) at the first BTS, selecting one data frame having less error(s).

2. A method for performing a diversity in an all Internet protocol (All IP) network, comprising the steps of:
a) at a first BTS, receiving a data frame from an IP network;
b) at the first BTS, duplicating the data frame;
c) at the first BTS, transmitting one of the duplicated data frames to a mobile station (MS) directly and the other to the MS through the second BTS;
d) at the MS, checking an error (or errors) in each of the data frames from the first and the second BTS; and
e) at the MS, selecting one data frame having less error(s).

3. A method for performing a diversity in an all Internet protocol (All IP) network, comprising the steps of:
a) at a frame selection/distribution means, receiving a first data frame through a first BTS and a second frame through a second BTS from a MS;
b) at the frame selection/distribution means, checking an error (or errors) in each of the first and the second data frames; and
c) at the frame selection/distribution means, selecting one data frame having less error(s).

4. The method as recited in claim 3, wherein the frame selection/distribution means is located in a radio access network (RAN) gateway.

5. A method for performing a diversity in an all Internet protocol (All IP) network, comprising the steps of:
a) at a frame selection/distribution means, receiving a data frame from an IP network;
b) at the frame selection/distribution means, duplicating the data frame;
c) at the frame selection/distribution means, transmitting one of the duplicated data frames to a mobile station (MS) directly and the other to the MS through the second BTS;
d) at the MS, checking an error (or errors) in each of the data frames from the first and the second BTS; and
e) at the MS, selecting one data frame having less error(s).

6. The method as recited in claim 5, wherein the frame selection/distribution means is located in a radio access network (RAN) gateway.

7. A method for performing a handoff in an all Internet protocol (All IP) network, comprising the steps of:
a) at a mobile station (MS) communicating with a first base transceiver station (BTS), determining whether a strength of a pilot signal from a second BTS is lager than a threshold value;
b) if the strength of the pilot signal from the second BTS is lager than the threshold value, at the MS, requesting a handoff add from the first BTS to the second BTS;
c) communicating with an Internet protocol (IP) network through the first BTS and the second BTS based on a diversity function;
d) determining whether a strength of a pilot signal from the first BTS is smaller than the threshold value;
e) if the strength of the pilot signal from the first BTS is smaller than the threshold value, requesting a handoff remove; and
f) releasing a traffic channel between the MS and the first BTS.

8. The method as recited in claim 7, wherein the step b) includes the steps of:
b1) establishing a traffic channel between the first BTS and the second BTS;
b2) establishing a traffic channel between the first BTS and a radio access network (RAN) gateway; and
b3) at the MS, receiving handoff direction information from the first BTS and the second BTS and establishing a traffic channel between the MS and the BTS B.

9. The method as recited in claim 7, wherein the step c) includes the steps of:
c1) at the first BTS, receiving a first data frame from a MS and a second data frame through a second BTS from the MS;
c2) at the first BTS, checking an error (or errors) in each of the first and the second data frames; and
c3) at the first BTS, selecting one data frame having less error(s).

10. The method as recited in claim 7, wherein the step c) includes the steps of:
c1) at the first BTS, receiving a data frame from an IP network;
c2) at the first BTS, duplicating the data frame;
c3) at the first BTS, transmitting one of the duplicated data frames to a mobile station (MS) directly and the other to the MS through the second BTS;
c4) at the MS, checking an error (or errors) in each of the data frames from the first and the second BTS; and
c5) at the MS, selecting one data frame having less error(s).

11. The method as recited in claim 7, wherein the step c) includes the steps of:
c1) at a frame selection/distribution means, receiving a first data frame through a first BTS and a second frame through a second BTS from a MS;
c2) at the frame selection/distribution means, checking an error (or errors) in each of the first and the second data frames; and
c3) at the frame selection/distribution means, selecting one data frame having less error(s).

12. The method as recited in claim 11, wherein the frame selection/distribution means is located in a radio access network (RAN) gateway.

13. The method as recited in claim 7, wherein the step c) includes the steps of:
c1) at a frame selection/distribution means, receiving a data frame from the IP network;
c2) at the frame selection/distribution means, duplicating the data frame;
c3) at the frame selection/distribution means, transmitting one of the duplicated data frames to the mobile station (MS) directly and the other to the MS through the second BTS;
c4) at the MS, checking an error (or errors) in each of the data frames from the first and the second BTS; and
c5) at the MS, selecting one data frame having less error(s).

14. The method as recited in claim 5, wherein the frame selection/distribution means is located in a radio access network (RAN) gateway.

15. A computer readable recording medium storing instructions for executing a method for performing a handoff in an all Internet protocol (All IP) network, comprising the steps of:
a) at a mobile station communicating with a first base transceiver station (BTS), determining whether a strength of a pilot signal from a second BTS is lager than a threshold value;
b) if the strength of the pilot signal from the second BTS is lager than the threshold value, adding a handoff from the first BTS to the second BTS;
c) communicating with the all IP network through the first BTS and the second BTS based on a diversity function;
d) determining whether a strength of a pilot signal from the first BTS is smaller than the threshold value;
e) if the strength of the pilot signal from the first BTS is smaller than the threshold value, requesting a handoff remove; and
f) releasing a traffic channel between the MS and the first BTS.
